(19) United States
(12) Patent Application Publication
(10) Pub. No.: US 2023/0127920 A1
(43) Pub. Date: Apr. 27, 2023

(54) SYSTEMS AND METHODS FOR INFORMATION MANAGEMENT SYSTEM TRANSACTION SCHEDULING AS WAIT-FOR-INPUT OR PSEUDO-WAIT-FOR-INPUT

(71) Applicant: BMC Software, Inc., Houston, TX (US)

(72) Inventors: Sagar Rajendraprasad Bansal, Pune (IN); Loc Dinh Tran, McLean, VA (US); Graham Fox, Trinity, TX (US)

(21) Appl. No.: 17/452,398

(22) Filed: Oct. 26, 2021

(51) Int. Cl. G06F 9/46; G06F 16/22; G06F 16/2457; G06F 16/248; G06N 20/00

(52) U.S. Cl. CPC G06F 9/466; G06F 16/2282; G06F 16/24573; G06F 16/248; G06N 20/00

(57) ABSTRACT

Systems and techniques for scheduling transactions as wait-for-input (WFI) or regions as pseudo-wait-for-input (P-WFI) include receiving a transaction report. The transactions from the transaction report are filtered using the plurality of metrics to generate a list of eligible WFI transactions or regions for running as P-WFI. The list of eligible WFI transactions or regions for running as P-WFI is filtered by applying a first system benchmark that is based on a total number of executed transactions to generate a list of top-eligible WFI transactions or regions for running as P-WFI. A total number of dedicated processing regions are calculated for each of the transactions on the list of top-eligible WFI transactions or regions for running as P-WFI. A scheduling report with a final list of top transactions eligible for scheduling as WFI or regions for running as P-WFI is generated based on the total number of dedicated processing regions.

### TECHNICAL FIELD

This description relates to systems and methods for tuning an IBM® IMS™ database management software system's scheduling as wait-for-input or pseudo-wait-for-input.

### BACKGROUND

Tuning the IBM® IMS™ database management software system (referred to throughout this document as IMS) is a difficult task. One of the most complex areas in tuning the IMS system is IMS transaction scheduling. An untuned IMS system can cause various issues, including transaction execution delay due to IMS regions not being available to schedule and the consumption of a greater number of central processing unit (CPU) cycles in the IMS control region (CTL) because the IMS scheduler has to search for an available region. In addition, for transactions that access an IBM® db2® data management product (referred to as db2 throughout this document), a large amount of CPU cycles may be needed to create an environment newly accessed by db2. Further, the untuned IMS system can also result in over-allocating system memory due to program preload, which causes paging in an operating system level. The untuned IMS system can also result in multiple additional input/output (I/O) cycles to load programs for scheduling. It is desirable to achieve improved IMS transaction scheduling through a technical solution to have a better tuned IMS system that avoids these negative technical problems.

### SUMMARY

According to one general aspect, a computer-implemented method or computer program product of a system for scheduling IMS transactions as wait-for-input (WFI) transactions or for scheduling regions as pseudo-wait-for-input (P-WFI) includes receiving a transaction report from a log dataset, where the transaction report lists multiple transactions, including a plurality of metrics for each of the transactions. The transactions from the transaction report are filtered using the plurality of metrics to generate a list of eligible WFI transactions or regions for running as P-WFI by excluding transactions scheduled as WFI, transactions that are not re-entrant, and transactions having a low volume number of transactions. The list of eligible WFI transactions or regions for running as P-WFI is filtered by applying a first system benchmark that is based on a total number of executed transactions to generate a list of top-eligible WFI transactions or regions for running as P-WFI. Transactions on the list of top-eligible WFI transactions or regions for running as P-WFI assigned to a same class are identified and the transactions assigned to the same class are marked for reassignment to a new class. A total number of dedicated processing regions are calculated for each of the transactions on the list of top-eligible WFI transactions or regions for running as P-WFI. A scheduling report with a final list of transactions that are top-eligible for scheduling as WFI or regions for running as P-WFI is generated based on the total number of dedicated processing regions, where the scheduling report includes a recommendation for each transaction on the final list of transactions to schedule as WFI or regions to schedule as P-WFI.

Implementations may include one or more of the following features. For example, transactions that access db2 may be flagged with a db2 access flag on the final list of transactions top-eligible for scheduling as WFI or regions for running as P-WFI, where generating the scheduling report includes generating the scheduling report based on the total number of dedicated processing regions and based on the db2 access flag.

In some implementations, the transactions on the scheduling report may be automatically scheduled for processing in a recommended number of dedicated processing regions.

A second system benchmark may be applied to the list of top-eligible WFI transactions or regions for running as P-WFI for a region threshold, where calculating the total number of dedicated processing regions for each of the transactions on the list of top-eligible WFI transactions or regions for running as P-WFI includes calculating the total number of dedicated processing regions based on the second system benchmark.

The scheduling report of the final list of transactions that are top-eligible for scheduling as WFI or regions for running as P-WFI identifies an amount of reduction of response time for each transaction top-eligible for WFI or region for running as P-WFI.

The plurality of metrics for each of the transactions includes a program schedule count, a transaction execution count, a total schedule to first Data Language Interface (DLI) time, a total schedule to first DLI CPU, and a total transaction response time.

The computer-implemented method or computer program product of a system for scheduling IMS transactions as wait-for-input (WFI) transactions or for scheduling regions as pseudo-wait-for-input (P-WFI) may implement a recommendation engine. The recommendation engine may be a component in IMS. The recommendation engine may be a component in the IMS system's transaction manager (TM).

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for IMS transaction scheduling and processing.

FIGS. 2A-2C illustrate an example flow diagram of a process for recommending transactions for scheduling as WFI or regions as P-WFI using the system of FIG. 1.

FIG. 3 is an example report of the IMS system's scheduling statistics report.

FIG. 4 is an example summary recommendation report.

FIG. 5 is an example detailed recommendation report.

FIG. 6 is an example detailed recommendation report at the transaction level.

### DETAILED DESCRIPTION

This document describes systems and techniques for improved IMS transaction scheduling that results in a better tuned IMS system. In general, IMS is a hierarchical database management software system for online transaction processing (OLTP) and online batch processing that may process thousands, millions, billions, and up to trillions of transactions over a period of time (e.g., over a day, week, etc.). The IMS system is used in many different industries including, for example, banking, travel, healthcare, communication, automotive, retail, manufacturing, oil and gas, energy, as well as other industries. The IMS system includes the IMS transaction manager (IMS TM) that manages, schedules, and performs online transaction processing for applications that access IMS data as well as data stored in the db2 database.

One aspect for tuning the IMS system is to improve the efficiency and scheduling of the IMS TM by defining transactions as wait-for-input (WFI) or defining regions as pseudo-wait-for-input (P-WFI). In other terms, defining transactions as WFI effectively allocates an IMS region or IMS address space as a WFI region for a selected transaction. Defining a region as running under P-WFI effectively allocates an IMS region or IMS address space as a P-WFI region. The WFI region or the P-WFI region defined for the selected transaction means that the selected region is already initialized to process additional transactions (or messages) identified to run on the selected region without having to reinitialize the region to process the additional transactions (or messages). When a transaction is defined as WFI, the IMS system starts the transaction running in the region and, upon completion of the execution of the transaction, the transaction remains in the region waiting for another same transaction or another message for a same transaction. In this manner, the transaction occupying the IMS region waits for the next message for the same transaction to execute without having to go through reinitialization and having to reinitialize the IMS region to execute that next message.

A goal of IMS transaction scheduling is to find and schedule transactions as WFI or executing in P-WFI in an efficient manner so that once the transaction completes, the transaction can remain in the same region and execute the next transactions. A challenge to selecting and defining transactions as WFI or running as P-WFI region is the limited number of regions in the IMS system that can be occupied. Thus, not every IMS transaction can be defined as WFI or P-WFI due to the limited number of regions.

The systems and techniques described herein identify the limited number of IMS regions as WFI or P-WFI and thus improve IMS transaction scheduling by designating IMS transactions to run as WFI or running in the P-WFI region. IMS transaction response time and transaction queuing time are improved by intelligently recommending which transactions to assign as WFI or running in the P-WFI region and how many WFI or P-WFI regions are required for each reassigned transaction. By using IMS log dataset(s), the systems and techniques described herein analyse each transaction based on various criteria, including the CPU usage for scheduling, the elapsed time for schedule to a first DLI call, the transaction elapsed time, class assignment, and other criteria. User input may be another criterion used to decide the eligibility for designating or recommending a transaction as WFI or running in the P-WFI region. These techniques result in an optimization for identifying which transactions to schedule as WFI and running in the P-WFI region and which IMS regions are WFI or P-WFI. In this manner, more efficient use of the IMS TM, including its components such as the IMS scheduler, and the resources the IMS scheduler are realized by consumers.

Additionally, the systems and techniques described herein reduce the need of experienced systems programmers to tune the IMS system, the time to analyse the data, and the guess work historically involved in designating transactions as WFI or running under the P-WFI region. The systems and techniques provide accurate suggestions for making changes to the system using precise metrics rather than guesswork. Using the described technical solutions for the above-identified technical problems results in multiple, realized improvements to the computing system. For example, the systems and techniques reduce transaction queue time since WFI transactions and/or transactions running under a P-WFI region do not go through complicated scheduling logic. The IMS program does not need to re-initialize and is ready to take on a new transaction. CPU consumption is reduced, especially for transactions accessing db2 database resources, because once a transaction is designated as WFI, the IMS scheduler does not need to use CPU resources to schedule subsequent transactions that can be executed by the existing WFI transaction in a particular region. The systems and techniques described herein reduce input/output (I/O) cycles by not having to load the application programs because the application programs are already scheduled in the region. Additionally, the systems and techniques described herein improve response time for other processes and cycles as a result of the total time reductions for many IMS and db2 transactions.

The following terms are used throughout this document:

PRSPGSCH—a program scheduling statistics report—this is a report that is created having multiple data points.

CSV—Comma separated values.

SLDS—an IMS system log data set—created by the IMS system to record the transactions occurring on the IMS system.

IRUF—an offline IMS resource utilization file for the BMC AMI Ops for IMS product.

REGION/MPR—an IMS Message processing region—this is a region or address space in the IMS system where transactions can be executed.

WFI—IMS Wait-for-input—a transaction that is designated as WFI and assigned to a region that it occupies, MPR, for approximately the next 64,000 iterations. When those iterations are completed, the IMS scheduler schedules another WFI transaction having the same criteria as the MPR-occupying transaction for execution during the next iterations. When a transaction is scheduled as WFI, the IMS scheduler selects an available MPR, and the IMS scheduler loads the appropriate program(s), creates the environment, optionally loads the transmission control protocol/internet protocol (TCP/IP or TCP IP) input for db2-based transactions in the selected MPR. The transaction executes in the MPR using the loaded resource and continues to occupy the MPR after execution of the transaction is completed. The scheduler places the MPR in a wait state and maintains the allocation. The scheduler only terminates the transaction if any of the following are true: The limit for the number of input messages processed or the processing time (PROCLIM) count is reached or a command to stop the MPR is entered.

P-WFI—IMS Pseudo-wait-for-input—a region or MPR designated P-WFI enables a region to remain scheduled as a P-WFI region and process additional messages for the same transaction until another input message appears for a different transaction. When a transaction is scheduled as P-WFI, the IMS scheduler selects an available MPR, and the IMS scheduler loads the appropriate program(s), creates the environment, and optionally loads the TCP IP input for db2-based transactions in the selected MPR. The transaction executes in the MPR using the loaded resource and continues to occupy the MPR after execution of the transaction is completed. The scheduler does not terminate the transaction when the transaction is completed. Instead, the scheduler maintains the region as P-WFI in a wait state for other transactions of the same class. When IMS needs the P-WFI region to schedule a transaction, IMS terminates the transaction and initializes the region for the new transaction.

db2—IBM® db2® Database

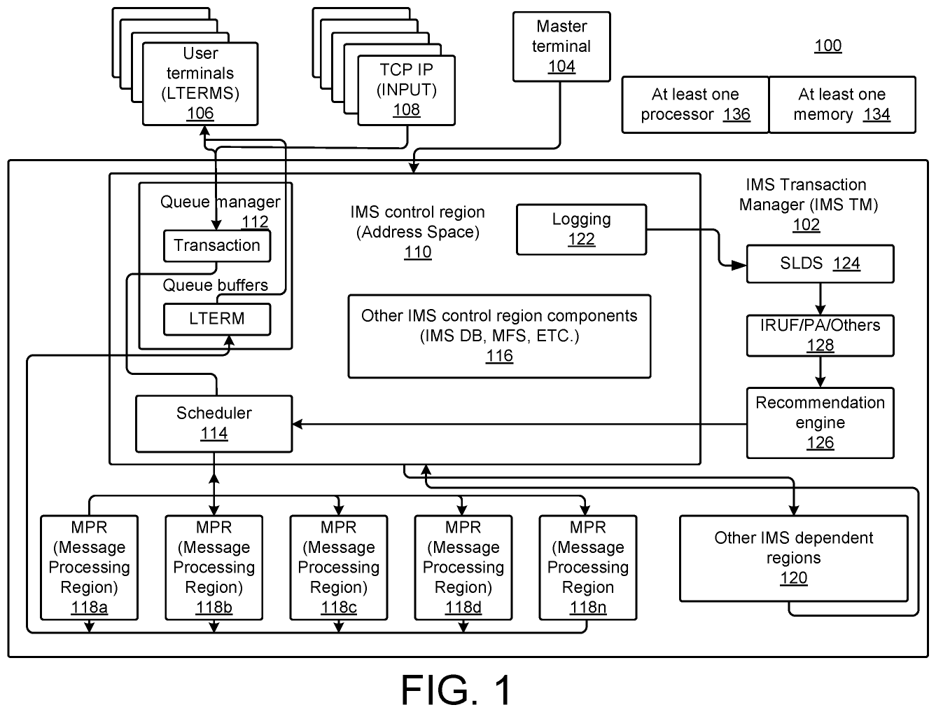

FIG. 1 is a block diagram of a portion of an example system 100 for IMS transaction scheduling and processing. The system 100 illustrates some components of the IMS system, including those components related to transaction scheduling and processing. It is understood by those skilled in the art that the system 100 may include other IMS components that are part of the IMS system, but that are not illustrated in this figure for simplicity of discussion.

The IMS system 100 includes an IMS transaction manager (IMS TM) 102. IMS TM 102 manages, schedules, and performs online transaction processing for applications that access the IMS system as well as data stored in the db2 database. IMS TM 102 may process different types of IMS messages including, for example, transactions, message-switches, and commands. Most types of IMS TM 102 message activity is in the form of transactions. Transactions may originate from various different sources depending on the type of industry or application using the IMS system. IMS TM 102 schedules and processes input messages from a variety of sources, processes messages sent outbound from IMS applications, and provides a message queuing and scheduling mechanism for messages in different MPR.

IMS TM 102 receives input from a master terminal 104, multiple user terminals 106 (also referred to as logical terminals (LTERMS) 106), and multiple TCP IP inputs 108. The master terminal 104, LTERMS 106, and TCP IP inputs 108 interact and exchange communications with IMS TM 102.

IMS TM 102 includes an IMS control region (address space) 110. IMS control region 110 controls how IMS makes data available to an end-user, controls a queue manager 112 to queue and manage transactions, and controls a scheduler 114 to schedule transactions for processing in one or more IMS regions. IMS control region 110 includes other IMS control region components 116 such as, for example, IMS DB, message format service (MFS), and other components. The queue manager 112 receives and stores messages, including transactions, by destination, priority, and the time of arrival in IMS. As discussed in more detail below, the scheduler 114 schedules the messages, including the transactions, for processing in the message processing regions (MPRs) 118a,-118n. A logging module 122 logs the transactions and stores the logged data in a system data log set (SLDS) 124. The recommendation engine 126 receives input from the SLDS 124 and data from the IMS resource utilization files (IRUFs), performance analyser (PA), and other files 128 to generate a recommendation for which transactions to designate as WFI and which regions to designate as P-WFI.

IMS TM 102 includes different types of IMS regions that are used to process messages. IMS TM 102 includes multiple message processing regions (MPRs) 118a-118n. MPRs 118a-118n that are the location where transactions are processed in real time. Other IMS dependent regions 120 may include batch message processing regions, JAVA processing regions, IMS fast path regions, and other types of regions. In some implementations, IMS TM 102 may include for example, 999 MPRs 118a-118n, and in some implementations, IMS TM 102 may include a different number of MPRs 118a-118n. It is understood that while only 5 MPRs are illustrated in FIG. 1, the reference numbers 118a-118n are meant to convey any number of MPRs including for example, 999 MPRs or a different number of MPRs.

In some implementations, each of the MPRs 118a-118n may be allocated to handle one transaction. Thus, for an IMS TM 102 having for example, 999 MPRs, a total of 999 transactions may be schedule for concurrent, parallel processing.

The response time of each IMS transaction is a critical performance criterion for an IMS system. Various factors impact response time of IMS transactions, such as transaction queuing, program scheduling, program execution, IMS database access, db2 database access, de-queue time, etc. Tuning of transaction scheduling is one of the ways to improve response time. Scheduling the transaction as WFI or regions as running P-WFI can reduce the schedule to the first DLI call time significantly improving the overall response time of the transaction. The first DLI call time is the amount of time it takes for the scheduler to load a program from the library to storage until the loaded program makes a first DLI call to the IMS system for the transaction. Not all transactions can or should be scheduled as WFI or for running in a P-WFI region. Various factors need to be considered for scheduling transactions as WFI or for running in a P-WFI region. Currently, system programmers consider some data points to guess which transactions should be scheduled as WFI or for running in a P-WFI region. The system and techniques described herein take the guess work out of scheduling transactions in the IMS system.

The system 100 also includes at least one memory 134 and at least one processor 136. The at least one processor 136 may represent two or more processors in the system 100 executing in parallel and utilizing corresponding instructions stored using the at least one memory 134. The at least one processor 136 may include at least one central processing unit (CPU). The at least one memory 134 represents a non-transitory computer-readable storage medium. Of course, similarly, the at least one memory 134 may represent one or more different types of memory utilized by the system 100. In addition to storing instructions, which allow the at least one processor 136 to implement the IMS TM 102 and its various components, the at least one memory 134 may be used to store data and other information used by and/or generated by the IMS TM 102 and the components used by the IMS TM 102.

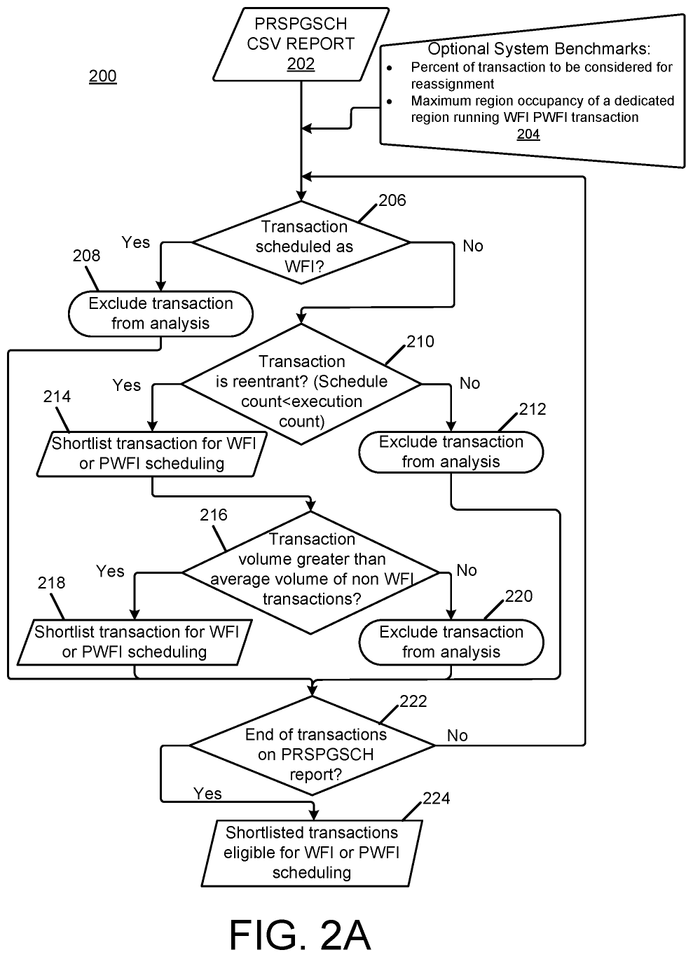

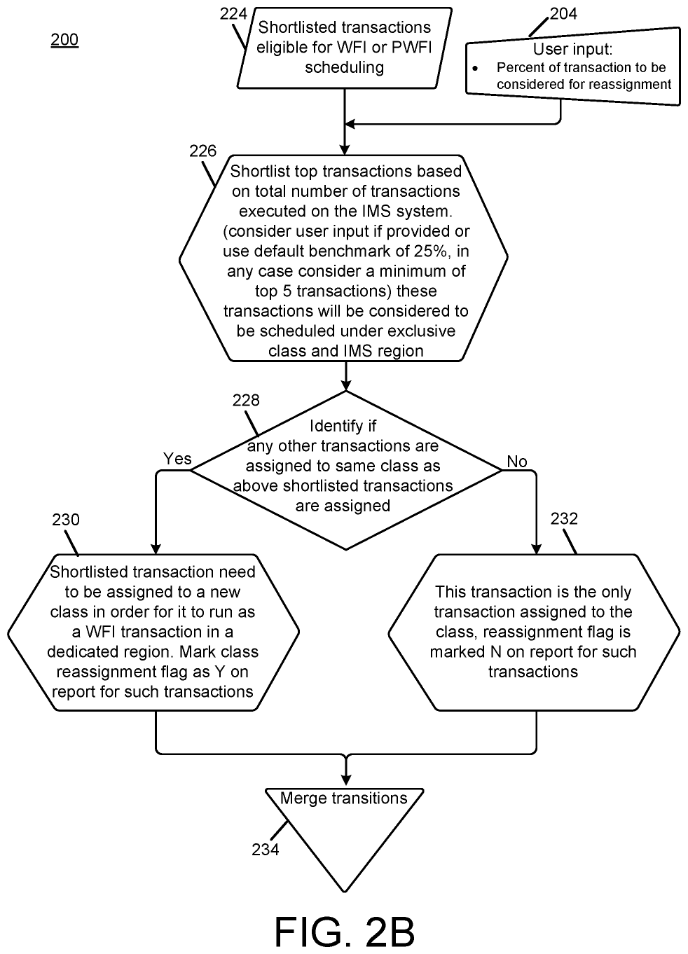

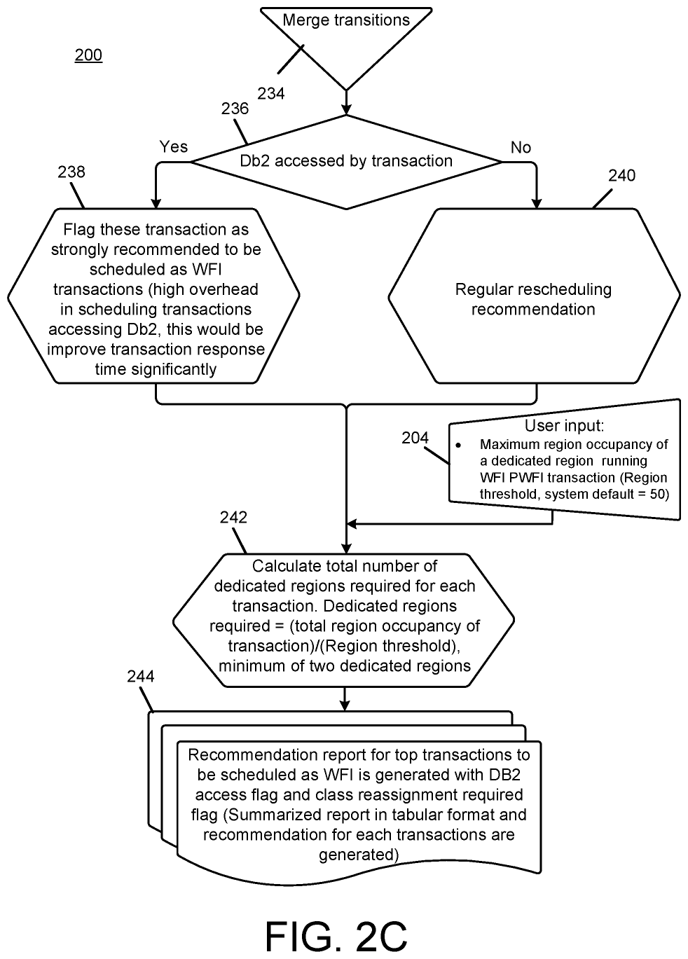

The techniques described below in FIGS. 2A-2C as implemented by the IMS TM 102 of FIG. 1, including the IMS control region 110, the queue manager 112, and the recommendation engine 126, analyse various data points as described below to generate WFI or P-WFI recommendations without adversely impacting resource utilization. This improves overall transaction response time and eliminates guess work, as well as achieves the other advantages and improvements described throughout this document. In some implementations, the output of the process of FIGS. 2A-2C automatically schedules the transactions for WFI or regions running as P-WFI, as recommended, for processing and execution in one or more designated MPRs 118a-118n.

FIGS. 2A-2C illustrate a process 200 a process for recommending transactions for scheduling as WFI or regions as P-WFI using the system of FIG. 1. Process 200 starts on FIG. 2A and continues onto FIGS. 2B and 2C.

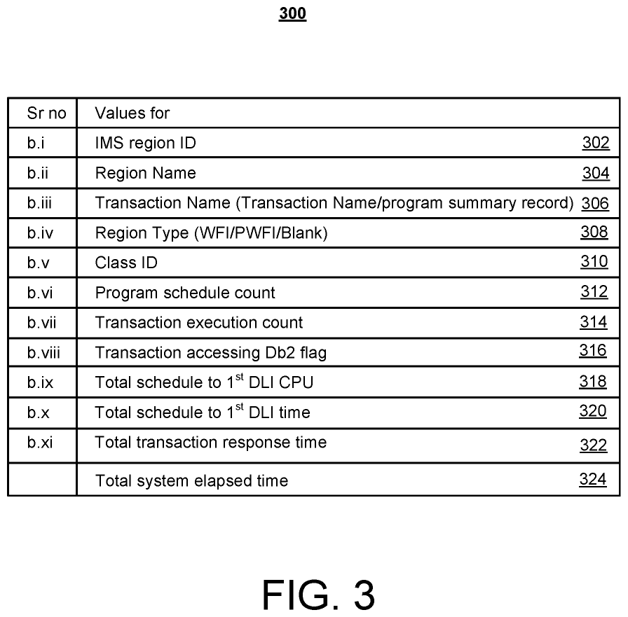

Referring to FIG. 2A, a PRSPGSCH CSV report (202) in character separated value format (CSV) is used as an input for this process. The PRSPGSCH CSV report has the following fields listed in example PRSPGSCH CSV report 300 (or report 300) of FIG. 3. In some implementations, other reports may be used or have the same or similar data as the report 300, including, for example, the IBM Performance Analyzer report, the IMS system's data communications (IMS/DC) monitor report, or other similar types of reports.

As illustrated in FIG. 3, the report 300 includes multiple data metrics. One metric includes a total duration for the input data being processed that is labelled Total System elapsed time 324. The first record of a CSV report has the start time of the first SLDS 124 log record and the end time of the SLDS log record from IRUF 128. For example, the total system elapsed time 324 may range from approximately multiple seconds to multiple hours to a day or to multiple days' worth of data for transaction processing. The recommendation engine 126 processes input data from SLDS 124 and IRUF 128 to find the total system elapsed time 324, where the total system elapsed time 324 equals the end time on last SLDS 124 record minus the start time on first SLDS 124 record.

The transaction name 306 refers to a name of the transaction associated with the IMS region ID 302.

The region type 308 refers to the type of a type of region that is designated for the transaction. For example, the type of region 308 may be designated as a WFI region, a P-WFI region, a non-designated or blank region, or other type of region.

The class ID 310 refers to the class identification for the transaction.

The program schedule count 312 refers to the number of schedules that take place in that MPR for the transaction.

The transaction execution count 314 refers to the number of transactions that execute within a period of time in the MPR.

The transaction accessing db2 flag 316 provides an indicator of whether or not the transaction accesses the db2 database. For example, if the flag is set (e.g., set to 1, True, etc.), then the transaction accesses the db2 database. If the flag is not set (e.g., blank or set to 0, False, etc.), then the transaction does not access the db2 database.

The total schedule to Pt DLI CPU 318 refers to a measure of the CPU resources that were consumed by the transaction during the period of time that starts when the scheduler retrieves the transaction from the queue manager until the Pt DLI call.

The total schedule to Pt DLI time 320 refers to an amount of time the transaction takes from the time the transaction entered the queue manager through the time the IMS TM schedules one of the MPR until the time the application performs a Pt DLI call.

The total transaction response time 322 refers to an amount of time the transaction takes as measured from the time the transaction enters the queue manager until the time the transaction completes with an output.

The metrics in the report are used to determine which future transactions should be designated as WFI and regions as P-WFI.

As illustrated in the example report 300 in FIG. 3, there is one unique record for every IMS Region ID 302 and a specific transaction name 306 on this report 300.

In step 204, additional, optional system benchmarks may be input into the scheduler. In some implementations, a user may be prompted to enter and/or confirm these system benchmarks. In some implementations, the system benchmarks may be automatically included as system defaults that are input to the recommendation engine 126 without user prompting or user intervention. In some implementations, the system benchmarks may be system defaults that are dynamically modified using a machine learning module and process. Using a machine learning process, the values for the system benchmarks dynamically change over time in a manner that further optimizes the recommendation engine 126. The system benchmark values include: a) A percentage of transactions to consider for reassignment to a dedicated MPR (between 0-100%); and/or b) A maximum region occupancy of a dedicated MPR running a WFI transaction or running as P-WFI region (validation values should be between 20-80%).

The report 300 in combination with the system benchmarks report the transactions that can be scheduled as WFI or regions as P-WFI to improve total transaction response 322 time by reducing the amount of time the scheduler 114 takes to schedule to the first DLI. The total transaction response time 322 metric is improved by the recommendation engine 126 using the inputs to improve scheduling to reduce the total schedule to 1st DLI time 320.

The recommendation engine 126 first determines if a new transaction is already scheduled as a WFI (206). That is, the recommendation engine 126 determines if a transaction is already allocated to an MPR 118a-118n. If the transaction is allocated to an MPR 118a-118n, then that transaction is excluded from the analysis (208). If the transaction is not already scheduled as a WFI transaction, then the transaction is processed for further analysis to determine if the transaction should be scheduled as a WFI transaction.

For a transaction not already scheduled as a WFI transaction, the recommendation engine 126 next determines whether or not the transaction is re-entrant (210). If the recommendation engine 126 determines that the transaction is not re-entrant, then the transaction is excluded from the analysis (212) and excluded from further consideration of being designated as a WFI transaction. In this manner, this avoids potential issues because if the non-re-entrant transaction is scheduled as a WFI transaction, the transaction could abend or have invalid data. If the recommendation engine 126 determines that the transaction is re-entrant, then the transaction is processed for further analysis to determine if the transaction should be scheduled as a WFI transaction.

The recommendation engine 126 determines whether or not the transaction is re-entrant by comparing the program schedule count metric to the transaction execution count metric. If the program schedule count metric is less than the transaction execution count metric, then the transaction is re-entrant and is processed by the recommendation engine 126 for further analysis. If the program schedule count metric is not less than the transaction execution count metric, then the transaction may not be re-entrant, and the recommendation engine 126 excludes the transaction from further analysis. In this manner, a transaction with an execution count of past transactions successfully executing without abending are processed by the recommendation engine 126 for further analysis.

More specifically, to find the re-entrant program not running as WFI or P-WFI, the recommendation engine 126 may perform the following steps:
a) build tables for WFI and non-WFI transactions;
b) from the table of non-WFI transactions (a) identify the re-entrant program by determining the program schedule count 312 that is less than the transaction execution count 314;
c) calculate the average transaction count of the non WFI transactions, where: Average transaction count=(Total non-WFI (a) transaction execution count) divided by the count of unique non-WFI transactions from (a) above); and
d) filter out transactions that are not re-entrant or have transaction execution count 314 less than the average transaction count calculated in (c) above from the tables (a) above.

With the above process, the recommendation engine 126 identifies the data of re-entrant transactions that are able to be scheduled as WFI or regions as P-WFI and that have a transaction count greater than the average transaction count. The shortlist of transactions that are re-entrant is further processed for WFI or P-WFI scheduling (214).

The scheduler 114 further evaluates the list of re-entrant transactions because not all of the re-entrant transactions should be scheduled as WFI or for running in a P-WFI region. The recommendation engine 126 evaluates the transaction volume of the re-entrant transactions on the list (216). If this transaction volume is greater than the average volume of non-WFI transactions, then the transaction remains on the shortlist of transactions for WFI or P-WFI scheduling (218). If this transaction volume is not greater than the average volume of non-WFI transactions, then the transaction is removed from the list and the transaction is excluded from further analysis (220). In this manner, low volume transactions as compared to other transactions are removed from the list and are not considered for further analysis.

For example, if the average volume of non-WFI transactions is 1000 transactions and the transaction volume for a class of transactions in the report is equal to 1000 transactions, then that transaction class is excluded from being designated or marked as a WFI transaction or for running in a P-WFI region. In this example, if the transaction volume for a class of transactions in the report is greater than 1000 transaction, then that transaction remains on the list for further processing for designation or marking as a WFI transaction or for running in a P-WFI region.

After filtering the CVS report based on the above criteria (already WFI, re-entrant, and volume) up to the end of the transactions on the PRSPGSCH report (222), the remaining shortlisted transactions are eligible for WFI or for P-WFI region scheduling by the scheduler 114 (224). Continuing on to FIG. 2B, one of the system benchmarks described above may be applied to this list of transactions. The system benchmark considered is the percent of transactions to be considered for reassignment (204). As discussed above, this system benchmark may be input by a user, such as a system programmer or may be a default benchmark. First, the recommendation engine 126 considers the data in the table created above in a) in descending order on transaction execution count field. Then, the recommendation engine 126 applies the system benchmark. If the system benchmark is not provided by a user, then a default system benchmark may be applied. For example, in some implementations a default system benchmark of 25% of transactions that should be scheduled as WFI may be applied. In some implementations, the default system benchmark may be a different percentage such as, for example, a percent anywhere in the range of from 1% to 100%. In some implementations, the default system benchmark is configurable and/or may be dynamically adjusted through machine learning techniques. In some implementations, the user input and/or the default system benchmark may be iteratively changed over time, taking into account varying loads and time of day.

After applying the system benchmark input, the recommendation engine 126 generates a shortlist of top transactions based on the total number of transactions executed on the IMS system (226). In some implementations, if no system benchmark is applied, a default minimum number of the top transactions are placed on the shortlist. For example, a minimum of the top 5 transactions may be placed on the shortlist. The shortlist or table includes transactions that will be considered to be scheduled under exclusive class and IMS region (226). From the table, the recommendation engine 126 finds the top percentage set for recommendation to run as WFI transaction and the rest of the transactions can be scheduled for running in a P-WFI region.

Next, the recommendation engine 126 identifies if any other transactions are assigned to the same class as the shortlisted transactions are assigned (228). If the recommendation engine 126 does find that the shortlisted transactions need to be assigned to the new class in order to run WFI transaction in a dedicated region, the class reassignment flag is marked as ‘Y’ on the recommendation report for such transactions (230). If the recommendation engine 126 does not find any other transactions assigned to the same class, then this transaction is the only transaction assigned to the class, and the reassignment flag is marked “N” on the recommendation report for such transactions (232). This process is repeated for all transactions in the table. Since WFI transactions require a dedicated class, each transaction with class reassignment value ‘Y’ on the report will be assigned a new class.

The recommendation engine 126 merges transactions that remain in the same class and transactions that have been reassigned to a new or different class (234).

Continuing on to FIG. 2C, the recommendation engine 126 then verifies whether the transaction accesses the db2 database subsystem (236) by checking the value on the CVS report. For transactions that access the db2 database, then the scheduler 114 flags these transactions as strongly recommended to be scheduled as WFI transactions (238) and sets the access flag on the recommendation report to ‘Y’. There is a high overhead in scheduling transactions that access the db2 database. These transactions are strongly recommended to be scheduled as WFI or for running in a P-WFI region because the transaction response time would be improved significantly. For transactions that do not access the db2 database, then the recommendation engine 126 sets the db2 access flag on the recommendation report to ‘N’ or, in some implementations, leaves the access flag blank and regular rescheduling is recommended (240).

The recommendation engine 126 then considers the second system benchmark regarding the maximum region occupancy of a dedicated region running a WFI transaction or dedicate a region for running as P-WFI (204). This system benchmark may be input by a user, such as a system programmer, or may be dynamically input from a separate machine learning process. In some implementations, the system benchmark may use a default value. In some implementations, the default value may be, for example, 50% for maximum region occupancy of a WFI MPR 118a-118n. It is understood that this default value is configurable and may be changed to any other percentage.

The recommendation engine 126 determines the region occupancy for the transaction by calculating the total number of dedicated regions required for each transaction (242).

The recommendation engine 126 calculates the total number of dedicated regions required for each transaction. The dedicated regions required are equal to the total region occupancy of transactions divided by the region threshold, for a minimum of two dedicated regions (242). The resulting number may be rounded to higher number regions required.

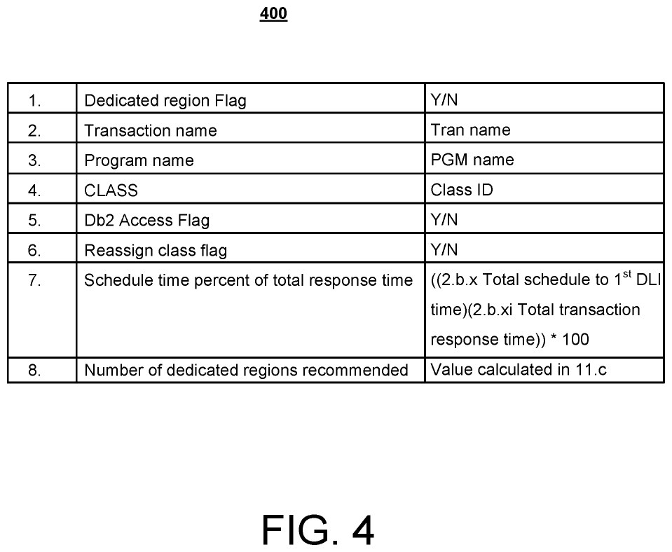

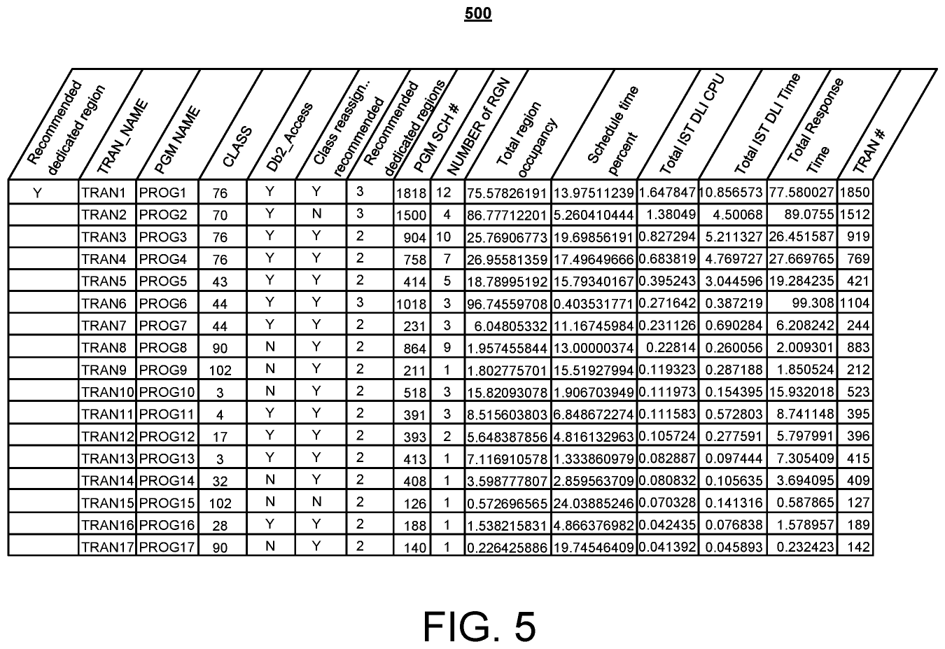

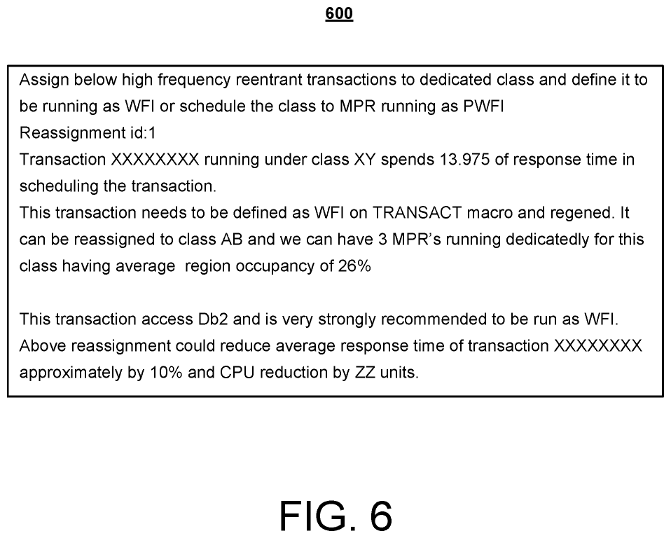

In some implementations, the scheduler 114 then outputs a recommendation report for the top transactions to be scheduled as WFI including the db2 access flag and class reassignment required flag (244). The recommendation report may be in various different formats. The recommendation report will be in two formats with one format a) illustrated in FIG. 4 in a summary tabular format with an example summary recommendation illustrated in FIG. 5; and the other format b) illustrated in FIG. 6 as a report listing actions required to implement recommendations, which may be for automatic scheduling and implementing. In some implementations, a user may select which transactions identified and recommended by the scheduler 114 to process by the IMS system as recommended.

For example, table 400 of FIG. 4 illustrates an output from the recommendation engine 126. The table 400 includes 1. a dedicated region flag; 2. a transaction name; 3. a program name; 4. class with Class ID; 5. a db2 access flag; 6. a reassign class flag; 7. a schedule time percent of total response time; and 8. a number of dedicated regions recommended.

In a similar manner, the table 500 of FIG. 5 provides similar information as the table 400 of FIG. 4, but in a different format along with some additional information. Table 500 includes a column for a recommended dedicated region for the transaction. Other columns in table 500 include transaction name (TRAN NAME), program name (PGM NAME), class, db2 Access flag, Class reassignment recommended flag, recommended number of dedicated regions, the program schedule number (PGM SCH #), the number of regions (RGN), the total region occupancy, the schedule time percent, the total number of CPU cycles until 1st DLI CPU call, the total time until 1st DLI time call, the total response time, and the number of transactions.

The table 600 in FIG. 6 lists the actions required to implement recommendations, which may be for automatic scheduling and implementing.

In some implementations, the recommendation engine 126 automatically defines the transactions on the recommendation report starting with the transactions at the top of the report as WFI or for running in a P-WFI region in the IMS TM 102.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for scheduling transactions as wait-for-input (WFI) or regions as pseudo-wait-for-input (P-WFI), the method comprising:
receiving a transaction report from a log dataset, the transaction report listing multiple transactions including a plurality of metrics for each of the transactions;
filtering the transactions from the transaction report using the plurality of metrics to generate a list of eligible WFI transactions or regions for running as P-WFI by excluding transactions scheduled as WFI, transactions that are not re-entrant, and transactions having a low volume;
filtering the list of eligible WFI transactions or regions for running as P-WFI by applying a first system benchmark that is based on a total number of executed transactions to generate a list of top-eligible WFI transactions or regions for running as P-WFI;
identifying transactions on the list of top-eligible WFI transactions or regions for running as P-WFI assigned to a same class and marking the transactions assigned to the same class for reassignment to a new class;
calculating a total number of dedicated processing regions for each of the transactions on the list of top-eligible WFI transactions or regions for running as P-WFI; and
generating a scheduling report with a final list of top-eligible transactions for scheduling as WFI or regions for running as P-WFI based on the total number of dedicated processing regions, wherein the scheduling report includes a recommendation for each transaction on the final list transactions to schedule as WFI or regions to schedule as P-WFI.

2. The computer-implemented method as in claim 1, further comprising:
flagging transactions that access db2 with a db2 access flag on the final list of top transactions eligible for scheduling as WFI or regions for running as P-WFI, and wherein generating the scheduling report includes generating the scheduling report based on the total number of dedicated processing regions and based on the db2 access flag.

3. The computer-implemented method as in claim 1, further comprising:
automatically scheduling the transactions on the scheduling report for processing in a recommended number of dedicated processing regions.

4. The computer-implemented method as in claim 1, further comprising:
applying a second system benchmark the list of top-eligible WFI transactions or regions for running as P-WFI for a region threshold, wherein calculating the total number of dedicated processing regions for each of the transactions on the list of top-eligible WFI transactions or regions for running as P-WFI includes calculating the total number of dedicated processing regions based on the second system benchmark.

5. The computer-implemented method as in claim 1, wherein the scheduling report identifies an amount of reduction of response time for each transaction eligible for WFI or region for running as P-WFI.

6. The computer-implemented method as in claim 1, wherein the plurality of metrics include a program schedule count, a transaction execution count, a total schedule to first DLI time, a total schedule to first DLI CPU, and a total transaction response time.

7. A computer program product for scheduling transactions as wait-for-input (WFI) or regions as pseudo-wait-for-input (P-WFI), the computer program product being tangibly embodied on a non-transitory computer-readable medium and including executable code that, when executed, is configured to cause a data processing apparatus to:
receive a transaction report from a log dataset, the transaction report listing multiple transactions including a plurality of metrics for each of the transactions;
filter the transactions from the transaction report using the plurality of metrics to generate a list of eligible WFI transactions or regions for running as P-WFI by excluding transactions scheduled as WFI, transactions that are not re-entrant, and transactions having a low volume;
filter the list of eligible WFI transactions or regions for running as P-WFI by applying a first system benchmark that is based on a total number of executed transactions to generate a list of top-eligible WFI transactions or regions for running as P-WFI;
identify transactions on the list of top-eligible WFI transactions or regions for running as P-WFI assigned to a same class and mark the transactions assigned to the same class for reassignment to a new class;
calculate a total number of dedicated processing regions for each of the transactions on the list of top-eligible WFI transactions or regions for running as P-WFI; and
generate a scheduling report with a final list of top transactions eligible for scheduling as WFI or regions for running as P-WFI based on the total number of dedicated processing regions, wherein the scheduling report includes a recommendation for each transaction on the final list transactions to schedule as WFI or regions to schedule as P-WFI.

8. The computer program product of claim 7, further comprising executable code that, when executed, is configured to cause the data processing apparatus to:
flag transactions that access db2 with a db2 access flag on the final list of top transactions eligible for scheduling as WFI or regions for running as P-WFI, and wherein generating the scheduling report includes generating the scheduling report based on the total number of dedicated processing regions and based on the db2 access flag.

9. The computer program product of claim 7, further comprising executable code that, when executed, is configured to cause the data processing apparatus to:
automatically schedule the transactions on the scheduling report for processing in a recommended number of dedicated processing regions.

10. The computer program product of claim 7, further comprising executable code that, when executed, is configured to cause the data processing apparatus to:
apply a second system benchmark the list of top-eligible WFI transactions or regions for running as P-WFI for a region threshold, wherein calculating the total number of dedicated processing regions for each of the transactions on the list of top-eligible WFI transactions or regions for running as P-WFI includes calculating the total number of dedicated processing regions based on the second system benchmark.

11. The computer program product of claim 7, wherein the scheduling report identifies an amount of reduction of response time for each transaction eligible for WFI or region for running as P-WFI.

12. The computer program product of claim 7, wherein the plurality of metrics include a program schedule count, a transaction execution count, a total schedule to first DLI time, a total schedule to first DLI CPU, and a total transaction response time.

13. A system for scheduling transactions as wait-for-input (WFI) or regions as pseudo-wait-for-input (P-WFI), the system comprising:
at least one processor; and
a non-transitory computer readable medium comprising instructions that, when executed by the at least one processor, cause the system to implement a recommendation engine that is configured to:
receive a transaction report from a log dataset, the transaction report listing multiple transactions including a plurality of metrics for each of the transactions;
filter the transactions from the transaction report using the plurality of metrics to generate a list of eligible WFI transactions or regions for running as P-WFI by excluding transactions scheduled as WFI, transactions that are not re-entrant, and transactions having a low volume;
filter the list of eligible WFI transactions or regions for running as P-WFI by applying a first system benchmark that is based on a total number of executed transactions to generate a list of top-eligible WFI transactions or regions for running as P-WFI;
identify transactions on the list of top-eligible WFI transactions or regions for running as P-WFI assigned to a same class and mark the transactions assigned to the same class for reassignment to a new class;
calculate a total number of dedicated processing regions for each of the transactions on the list of top-eligible WFI transactions or regions for running as P-WFI; and
generate a scheduling report with a final list of top transactions eligible for scheduling as WFI or regions for running as P-WFI based on the total number of dedicated processing regions, wherein the scheduling report includes a recommendation for each transaction on the final list transactions to schedule as WFI or regions to schedule as P-WFI.

14. The system of claim 13, wherein the recommendation engine is further configured to:
flag transactions that access db2 with a db2 access flag on the final list of top transactions eligible for scheduling as WFI or regions for running as P-WFI, and wherein generating the scheduling report includes generating the scheduling report based on the total number of dedicated processing regions and based on the db2 access flag.

15. The system of claim 13, wherein the recommendation engine is further configured to:
automatically schedule the transactions on the scheduling report for processing in a recommended number of dedicated processing regions.

16. The system of claim 13, wherein the recommendation engine is further configured to:
apply a second system benchmark the list of top-eligible WFI transactions or regions for running as P-WFI for a region threshold, wherein calculating the total number of dedicated processing regions for each of the transactions on the list of top-eligible WFI transactions or regions for running as P-WFI includes calculating the total number of dedicated processing regions based on the second system benchmark.

17. The system of claim 13, wherein the scheduling report identifies an amount of reduction of response time for each transaction eligible for WFI or region for running as P-WFI.

18. The system of claim 13, wherein the plurality of metrics include a program schedule count, a transaction execution count, a total schedule to first DLI time, a total schedule to first DLI CPU, and a total transaction response time.

19. The system of claim 13, wherein the recommendation engine is a component in a mainframe computing system.

20. The system of claim 13, wherein the recommendation engine is a component in an information management system transaction manager (IMS TM).
